(19) United States
(12) Patent Application Publication
(10) Pub. No.: US 2004/0054700 A1
(43) Pub. Date: Mar. 18, 2004

(54) Backup method and system by differential compression, and differential compression method

(75) Inventor: Yoshiyuki Okada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/642,148

(22) Filed: Aug. 18, 2003

(30) Foreign Application Priority Data
Aug. 30, 2002 (JP) 2002-255150

(51) Int. Cl. G06F 17/30; G06F 15/16

(52) U.S. Cl. 707/204; 709/203

(57) ABSTRACT

A backup method by differential compression back up the data of a client by the server so as to decrease overhead at backup. After the client creates the associated differential compression data before backup, the client connects with the server and transfers the created differential compression data groups and association information to the server, and the server saves the difference compression data groups to a storage medium according to the association information, and disconnects the connection. When the data is restored, the server reads the saved differential compression data groups according to the association information and transfers the data to the client, and the client decompresses and develops the differential compression data groups according to the association information, and rebuilds the data.

### BACKGROUND OF THE INVENTION

1. Field of the Invention

The present invention relates to a backup method and system by differential compression and a differential compression method for exchanging difference data extracted from new and old files between a client and a server to backup the data, and more particularly to a backup method and system by differential compression and a differential compression method suitable for a system which performs backup between remote locations via a narrowband WAN.

2. Description of the Related Art

A client server model for using a server to backup a client (terminal) has been used. For backup with this model, a method for saving data held by a plurality of clients to a server via LAN (Local Area Network), and a method to backup data via WAN (Wide Area Network) between LAN and LAN have been used.

In the latter case in particular, critical data, such as banking data, is often backed up to a remote location, so that the data can be restored even if an accident or disaster occurs. In such a case, a long distance narrowband WAN is used, so in order to prevent traffic bottlenecks and to decrease load on the net, data volume to be sent must be minimized (or transmission time must be minimized).

FIG. 23 is a diagram depicting a conventional full backup method. In a full backup method, an original file, updated file thereof (original file remains and a new file is created), and the changed file (original file is overwritten) are all saved from the client to the server in the original format (size) at the time of backup.

In FIG. 23, for example, the original four files (A, B, C, D) are first saved from the client to the server at time T1. Then at time T2, excluding the files deleted due to an update and for other reasons (D, C1), seven files (A, B, B1, C, C2, D1, E), which include newly added files (B1, C2, D1, E), are transferred from the client to the server at the period between times T1-T2.

In this method, slightly updated or changed similar files are sent as is, so a data volume close to double the size is sent, thereby decreasing the transmission data volume is not an issue.

In order to decrease the transmission data volume of a backup, the file differential backup method shown in FIG. 24 has been proposed. In the case of a conventional file differential backup method, only the files changed during the period between times T1-T2 (updated, changed, and newly added B1, C2, E) are saved from the client to the server at time T2, as shown in FIG. 24.

Therefore data can be saved with a data volume less than the full backup method. However, an individual file that was updated or changed is sent as the original size, even if the file is similar to the original file, so efficiency is not very good.

So as a method for further improving transfer efficiency, a backup method using difference data compression Δ(B−B1) between the original file and the updated or changed file has been proposed. FIG. 25 is a diagram depicting the backup method by a conventional difference data compression.

As FIG. 25 shows, when the original file B and the file B1, which is a corrected (updated or changed) file B exists at the client side, differential compression processing between the original file B and the corrected file B1 is performed, and only the difference data Δ(B−B1) is transmitted to the server side.

At the server side, the updated file B1 is created from the transmitted original file B and the difference data Δ(B−B1) (this of course includes link association information thereof), and is saved. And to restore the data, the server side reads the original file and the update file and returns them to the client side. The client completes the restore operation by the updated file.

Such a known backup method using differential data compression is, for example, U.S. Pat. No. 5,634,052 (system for reducing storage requirements and transmission loads in a backup sub-system in client—server environment by transmitting only delta files from client to server).

The backup method by difference data, which was disclosed by this prior document, will be described in detail with reference to FIG. 26 to FIG. 28. At first, the differential transfer flow at the client side will be described with reference to FIG. 26. Here one file A and the corrected file thereof will be described as the target, but other files are processed in a similar way.

S1: Client establishes connection with server.

S2: First original file A is selected.

S3: If the file A has been corrected since the previous backup, processing advances to step S4, otherwise processing advances to step S6.

S4: If the version of the copy file F (nothing is saved in the beginning), which is temporarily saved in the cache, is older then file A, processing advances to step S8, and if not older processing advances to step S5.

S5: File A is sent to the server as is, and a copy of the file A is stored in F in the cache.

S6: If all the target files are transmitted processing ends, otherwise processing advances to step S7.

S7: Next file A is selected and processing returns to step S3.

S8: If the file A is a corrected file, difference Δ=diff(F, A) between the original file F and the file A is calculated, and the difference data is transmitted to the server instead of the corrected file. Also a copy of the file A is stored in F in the cache.

In this way, while adhering to the version of the file A, the difference between the old file and the new file is transmitted (backed up) to the server side.

Now the flow of difference data transfer processing at the server side corresponding to the above flow will be described with reference to FIG. 27.

S11: Connection with the client is established

S12: If all the target data is received, processing ends, otherwise, processing advances to step S13.

S13: File A or difference data Δ is received from the client.

S14: The file group, related to the file A and the difference data Δ, which has been stored thus far, and the link information: [F, Δ1, Δ2 . . . Δm] is read.

S15: If the received file is the original file A, processing advances to step S16, otherwise processing advances to step S17.

S16: For the original file A, the difference Δ′=diff(A, F) from the copy file F which was backed up the previous time (backward difference shown in FIG. 29), is calculated. And [A, Δ′, Δ1, . . . Δm] is stored as a new file group and link information.

S17: Assuming that the transmitted data is difference data, the difference is developed from F and A, and the corrected file A′=R(Δ, F) is restored. Then the difference data Δ′=diff(A′, F) is recreated as the backward difference. And [A′, Δ′, Δ1, . . . Δm] is stored as a new file group and link information.

As mentioned above, the server side replaces the forward difference (difference when a new file is subtracted from an old file, see FIG. 29) sent from the client side with the backward difference, and backs up the data.

In other words, the flow charts in FIG. 26 and FIG. 27 summarize the backup procedure using the differential compression between client-server in FIG. 28. In other words, the client side establishes a connection with the server, and the server side establishes a connection with the client (S1, S11). Then the client side creates the difference data, and the client side transmits the difference data to the server side (S8). If the client side has not transmitted all the target data, processing returns to the creation of difference data (S6).

The server side receives the difference data (S13). Then the difference of the transmitted difference data is developed, and the backward difference is recreated and saved (S16, S17). If the server side has not received all the target data, processing returns to the reception of the difference data (S12).

Finally the client side disconnects connection with the server, and completes transfer. Also the server side disconnects connection with the client, and completes transfer.

There are two types of categories for the basic method to determine the difference data, forward and backward, as shown in FIG. 29. (For an example, see reference material: Randal C. Burns, Darrell D. E. Long, “Efficient Distributed Backup with Delta Compression”, Proceedings of the Fifth Workshop on I/O in Parallel and Distributed Systems, ACM: San Jose, November 1997, pp. 26-36.)

As a direction to determine difference, there is forward difference, which determines the difference of a new file from an old file, and backward difference, which determines the difference of an old file from a new file. As an interval to determine difference, there is linear difference, which determines the difference between the closest versions, and jump difference, which determines the difference between distant versions.

As FIG. 28 and FIG. 30 show, in the case of a backup method using conventional difference data, the client side creates each difference data and transfers it to the server side after connection between client and server is established, and the server side replaces the received difference data with the back difference, and saves it, then the connection between the client and server is disconnected.

Because of this, the overhead of processing during connection is high, which makes the connection time longer, and the total backup takes time. Especially when a long distance narrowband communication network is used, communication fees become expensive, and there is the problem when regular backup is performed for many clients using one server.

Also conventionally there are four types of differential compression methods for the differential compression method, as shown in FIG. 29. However, in the case of linear difference, the difference size is small since the difference between neighboring files is determined, but it takes time to restore the data between distant files.

In the case of jump difference, on the other hand, the data can be restored all at once, even between distant files, but the difference size increases.

### SUMMARY OF THE INVENTION

With the foregoing in view, it is an object of the present invention to provide a backup method and a system thereof by differential compression for decreasing the overhead during connection between the client and server, and decreasing the total backup time.

It is another object of the present invention to provide a backup method and a system thereof by differential compression for decreasing processing at the server side, even when differential compression is performed, and for decreasing the backup processing load from many clients.

It is still another object of the present invention to provide a differential compression method for performing differential compression, which allows coarse file restoration processing according to the request of the user.

To achieve these objects, the present invention is a backup method by differential compression for backing up the data of a client by a server, including a step of creating associated differential compression data groups associated with each other before backup, a step of connecting with a server and transferring the differential compression data groups and association information created by a client to the server at backup, a step of saving the differential compression data groups to a storage medium according to the transferred association information, then disconnecting the connection, a step of reading the saved differential compression data groups according to the association information, and transferring the read data to the client when the data is restored, and a step of decompressing and developing the differential compression data groups according to the transferred association information, and rebuilding the data with the client.

The backup system using differential compression for a server backing up data of a client according to the present invention includes a client which creates associated differential compression data groups before backup, then connects with the server and transfers the created differential compression data groups and association information to the server at backup, and a server which saves the differential compression data groups to a storage medium according to the transferred association information, and disconnects the connection. When the data is restored, the server reads the saved differential compression data groups according to the association information, transfers it to the client, and the client decompresses and develops the differential compression data groups according to the transferred association information, and rebuilds the data.

In the present invention, the creation of difference data is completed by the client before establishing a connection with the server, and after establishing the connection, the client sends the already created difference data, and the server receives the difference data sent from the client and saves the difference data as is (re-conversion, such as reciprocal difference, is not performed), so the total backup time can be decreased by eliminating overhead. In particular, the load of backup processing from a plurality of clients can be decreased, because of minimizing processing at the server side.

In the present invention, it is preferable that linear difference in the forward direction in time from old data to new data is determined when the client associates the differential compression data, or in the present invention, it is preferable that the linear difference in the backward direction in time from the new data to old data is determined when the client associates the differential compression data, so that the differential format based on the request of the user can be implemented.

In the present invention, it is preferable that the client creates the differential compression data in batch immediately before backup according to the association to create the differential compression data, or that the client creates the differential compression data non-periodically between backup and backup along with the association to create the differential compression data.

By this, differential processing according to the performance of the client and the preference of the user becomes possible.

In the present invention, it is preferable that the client creates the differential compression data in the backward direction non-periodically between backup and backup along with the association for the creation of the differential compression data, rearranges the backward difference data into the opposite direction, and transfers the data.

In the present invention, it is preferable that the server saves the difference data groups according to the forward linear association when the differential compression data groups are saved to a storage medium, or that the server saves the difference data groups according to the backward linear association when the differential compression data groups are saved to a storage medium.

The differential compression method of the present invention is a differential compression method for associating data groups, which are changed or updated with the difference between the new and old data, including a step of performing the jump difference in the forward direction from the first file to the last file, and a step of performing the linear difference in the backward direction from the last file, to the file next, to the first file.

The differential compression method of the present invention is a differential compression method for associating data groups, which are changed or updated with the difference between the new and old data, including a step of performing the jump difference in the backward direction from the last file to the first file, and a step of performing the linear difference in the forward direction from the first file to the file just before the last file.

The differential compression method of the present invention is a differential compression method for associating the data groups, which are changed or updated by the difference between the new and old data, comprising a step of performing the jump difference in the forward direction from the first file to the last file, a step of performing the linear difference in the backward direction from the last file to a mid-way file, and a step of performing the linear difference in the forward direction from the first file to a file just before the mid-way file.

It is preferable that the present invention further comprises a step of defining the mid-way file by regarding a location where the line difference size is largest as the breakpoint of association.

The differential compression method of the present invention can provide difference creation combining the forward/backward directions and the linear/jump differences according to the manner of restoring the file desired by the user, in order to restore or recover the file from the difference data according to the user request (quickly restoring or recovering a desired file).

### BRIEF DESCRIPTION OF THE DRAWINGS

FIG. 1 is a diagram depicting a configuration of the backup system of the client-server model according to an embodiment of the present invention;

FIG. 2 is a diagram depicting a configuration of the backup system of the client-server model according to another embodiment of the present invention;

FIG. 3 is a diagram depicting a basic concept of the backup system by a difference data transfer according to the present invention;

FIG. 4 is a flow chart depicting the backup processing between the client and server according to an embodiment of the present invention;

FIG. 5 is a diagram depicting an operation of the backup processing according to an embodiment of the present invention;

FIG. 6 is a flow chart depicting batch difference creation and forward difference transfer processing according to the first embodiment of the differential compression method in FIG. 3;

FIG. 7 is a flow chart depicting the difference data creation processing in FIG. 6;

FIG. 8 is a flow chart depicting the batch difference creation and backward difference transfer processing according to the second embodiment of the differential compression method of the client in FIG. 3;

FIG. 9 is a flow chart depicting the difference data creation processing in FIG. 7;

FIG. 10 is a flow chart depicting the non-periodic difference creation and forward difference transfer processing according to the third embodiment of the differential compression method of the client in FIG. 3;

FIG. 11 is a flow chart depicting the difference data creation processing in FIG. 10;

FIG. 12 is a flow chart depicting the non-periodic difference creation and backward difference transfer processing according to the fourth embodiment of the differential compression method of the client in FIG. 3;

FIG. 13 is a flow chart depicting the difference data creation processing in FIG. 12;

FIG. 14 is a flow chart depicting the backup processing of the forward difference according to the first embodiment of the server in FIG. 3;

FIG. 15 is a flow chart depicting the backup processing of the forward difference according to the second embodiment of the server in FIG. 3;

FIG. 16 is a diagram depicting the differential compression method of the present invention;

FIG. 17 is a flow chart depicting the difference creation processing according to the first differential compression method in FIG. 16;

FIG. 18 is a flow chart depicting the difference development processing according to the first differential compression method in FIG. 16;

FIG. 19 is a flow chart depicting the difference creation processing according to the second differential compression method in FIG. 16;

FIG. 20 is a flow chart depicting the difference development processing according to the second differential compression method in FIG. 16;

FIG. 21 is a flow chart depicting the difference creation processing according to the third differential compression method in FIG. 16;

FIG. 22 is a flow chart depicting the difference development processing according to the third differential compression method in FIG. 16;

FIG. 23 is a diagram depicting a conventional full backup method;

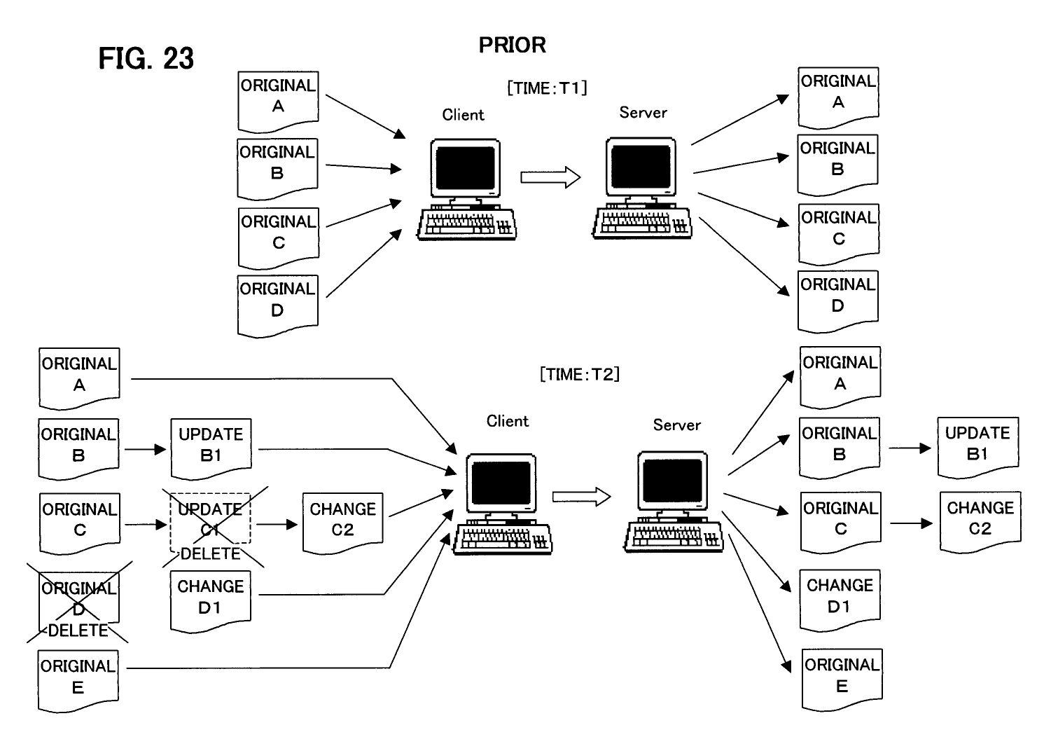

FIG. 24 is a diagram depicting a conventional differential backup method;

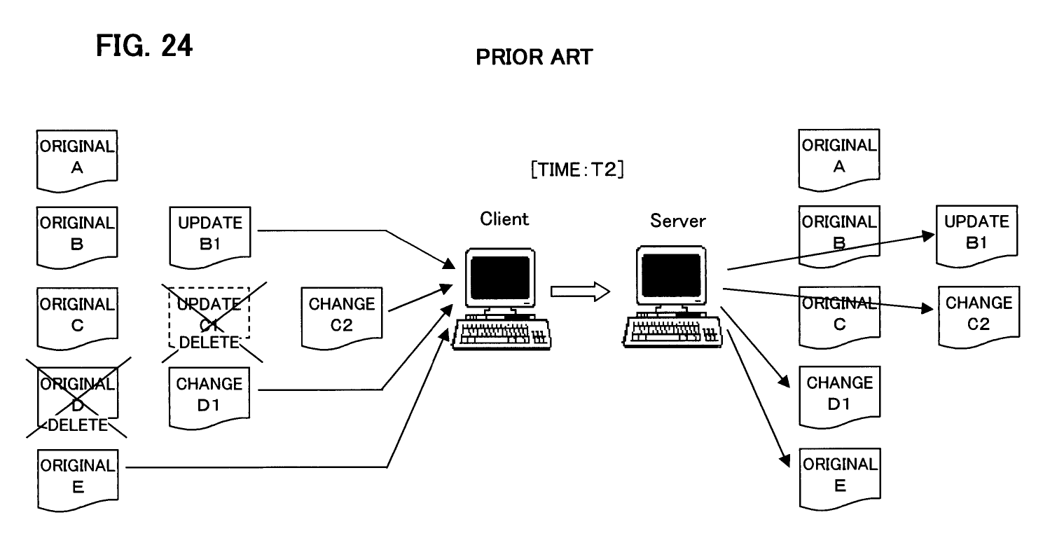

FIG. 25 is a diagram depicting a conventional difference data backup method;

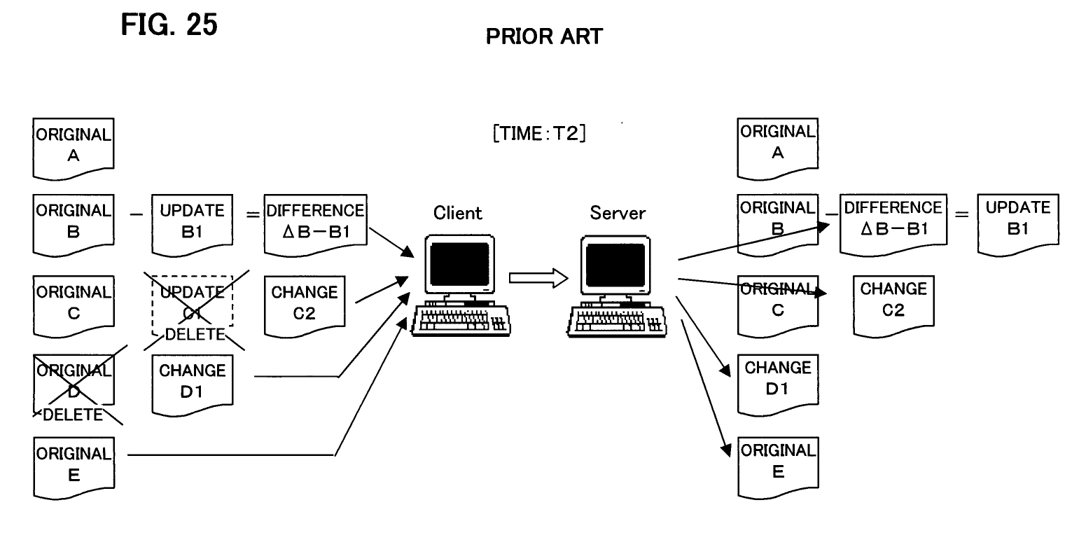

FIG. 26 is a flow chart depicting a conventional difference transfer processing by the client shown in FIG. 25;

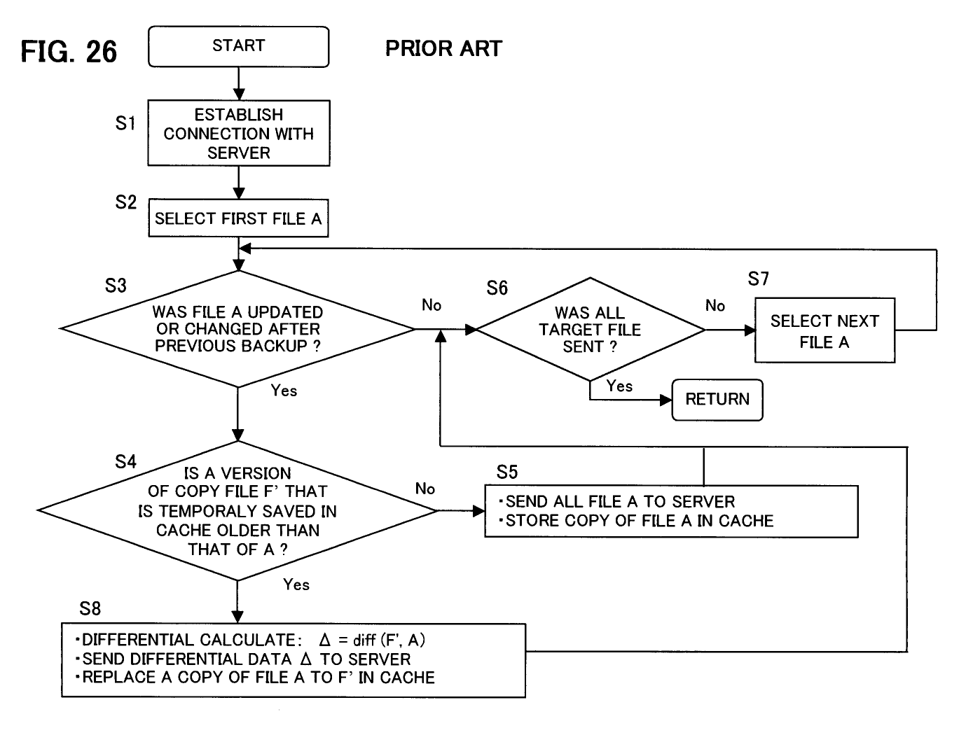

FIG. 27 is a flow chart depicting a conventional difference resend processing by the server shown in FIG. 25;

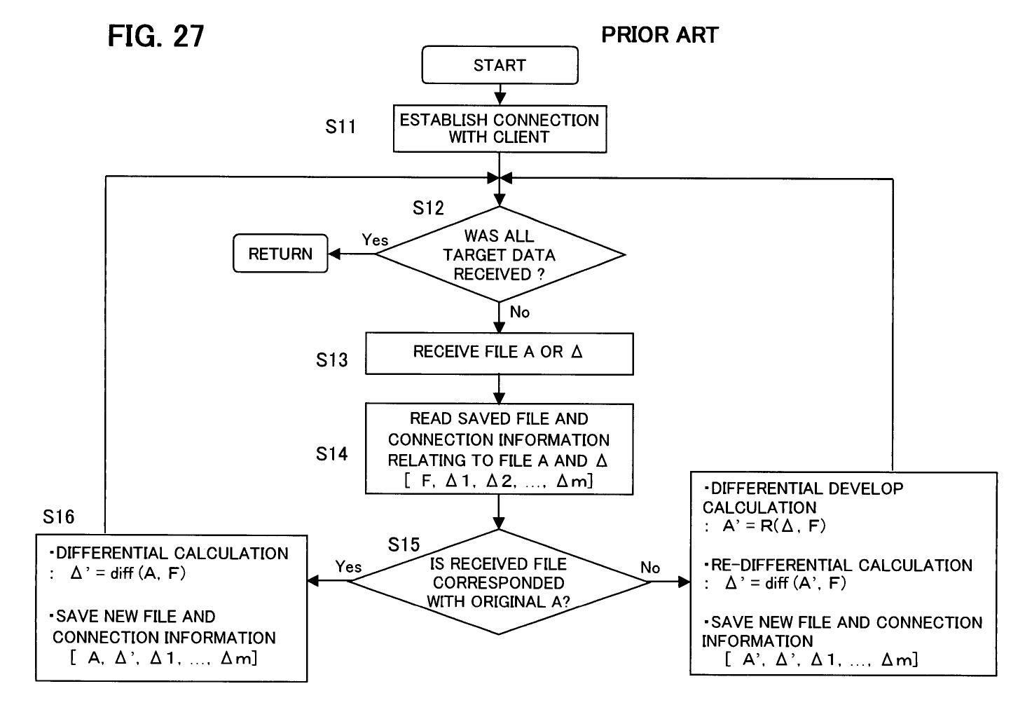

FIG. 28 is a diagram depicting a conventional procedure of the client-server shown in FIG. 25;

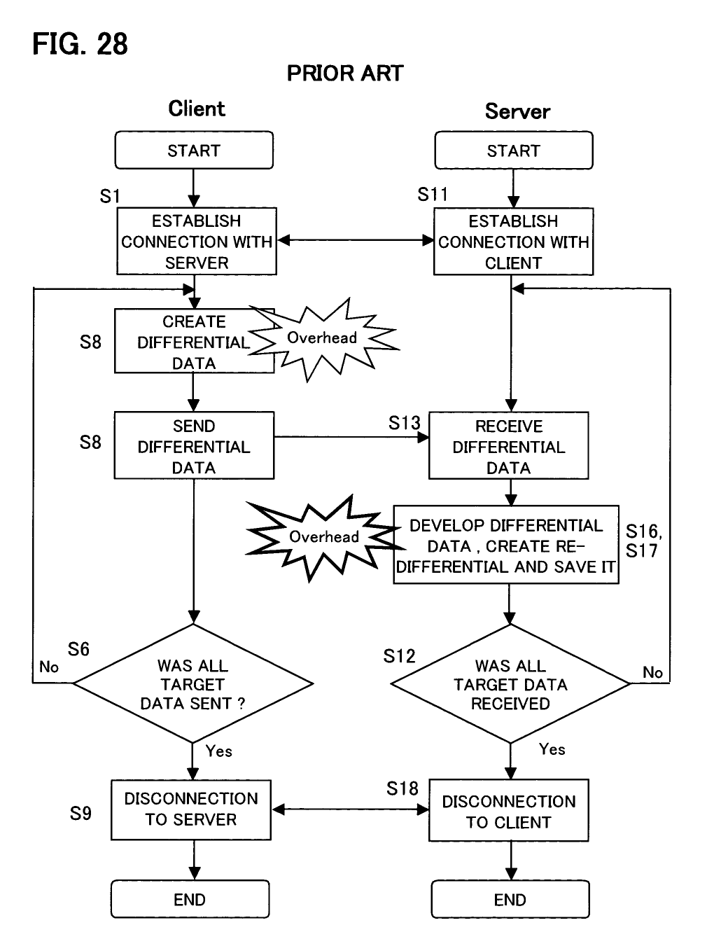

FIG. 29 is a diagram depicting a conventional differential compression method; and

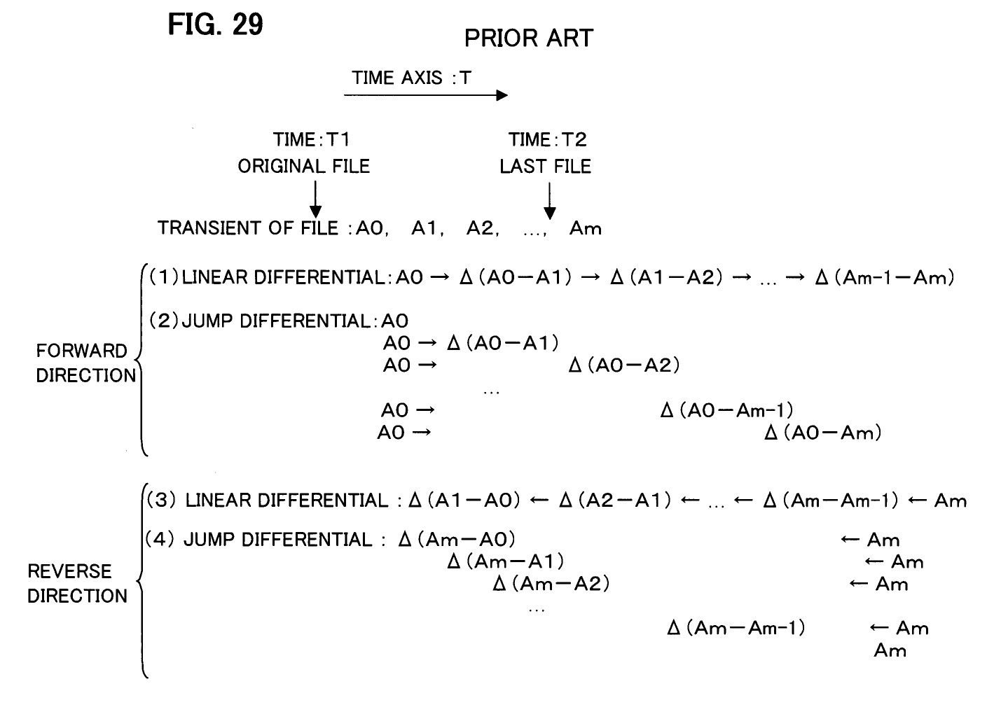

FIG. 30 is a diagram depicting a problem of prior art in FIG. 25.

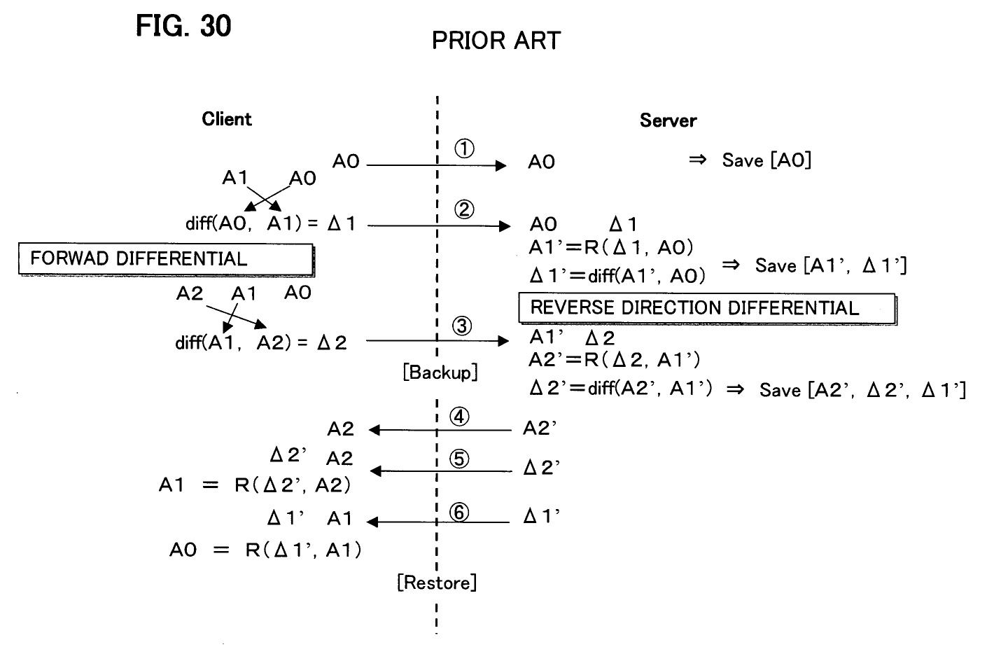

### DESCRIPTION OF THE PREFERRED EMBODIMENTS

Embodiments of the present invention will now be described in the sequence of backup system using differential compression, processing by client, processing by server, differential data compression method, and other embodiments.

[Backup System Using Differential Compression]

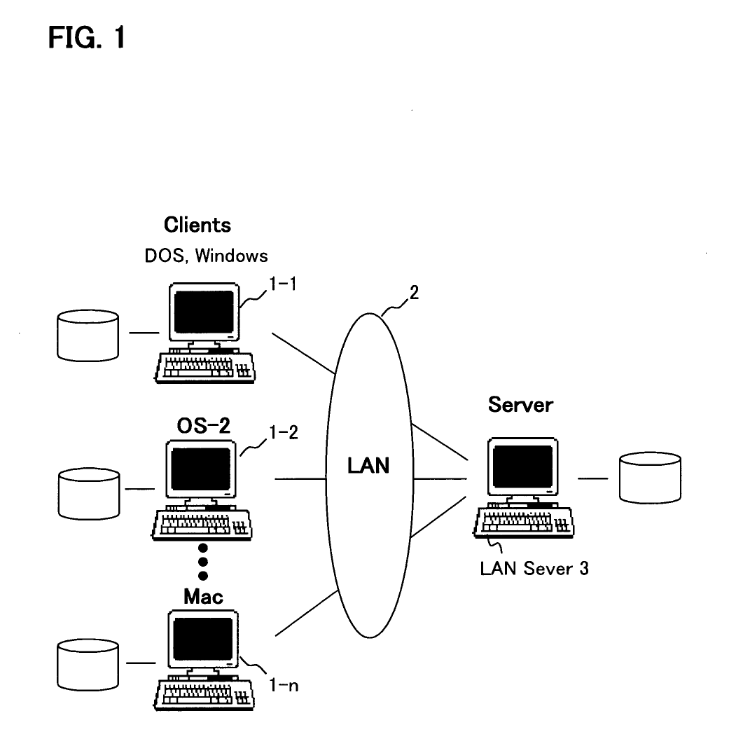

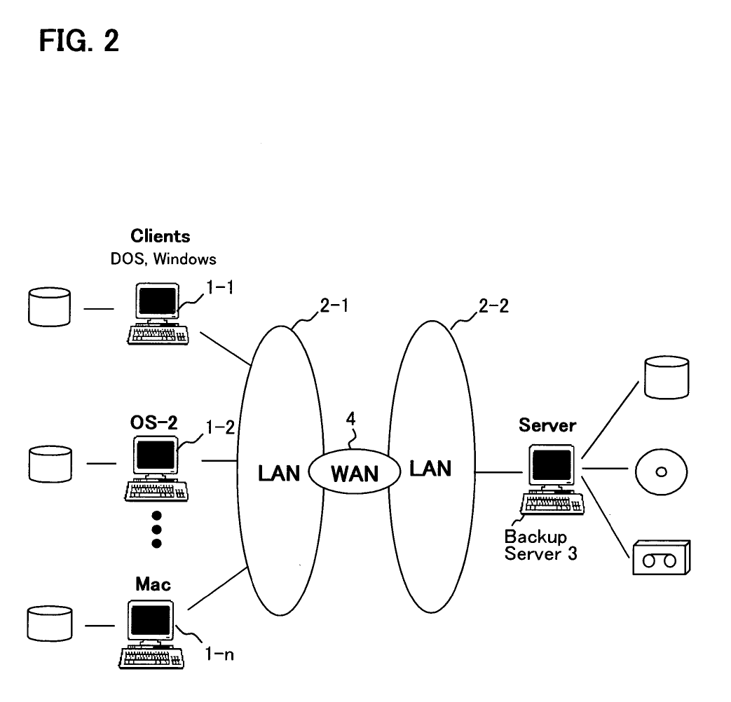

FIG. 1 is a block diagram depicting the first embodiment of the backup system in the client-server model of the present invention, and FIG. 2 is a block diagram depicting the second embodiment of the backup system in the client-server model of the present invention.

As FIG. 1 shows, a plurality of clients 1-1, 1-2 and 1-n are connected to the LAN server 3 via the LAN (Local Area Network) 2. The data held by the plurality of clients 1-1, 1-2, and 1-n is saved to the server 3 via the LAN 2.

In the system shown in FIG. 2, a plurality of clients 1-1, 1-2 and 1-n are connected to the backup server 3 via the LAN (Local Area Network) 2-1, WAN (Wide Area Network) 4, and LAN 2-2. The data held by the plurality of clients 1-1, 1-2 and 1-n is saved to the server 3 via the LAN 2-1, 2-2, and WAN 4.

In particular, the system shown in FIG. 2 is used for backing up such critical data as banking data to a remote area so that the data can be restored even if an accident or disaster occurs. In this case, a long distance narrowband WAN 4 is used, so the volume of data to be transmitted (or the transmission time) must be minimized to decrease the load on the network in order to prevent traffic bottlenecks.

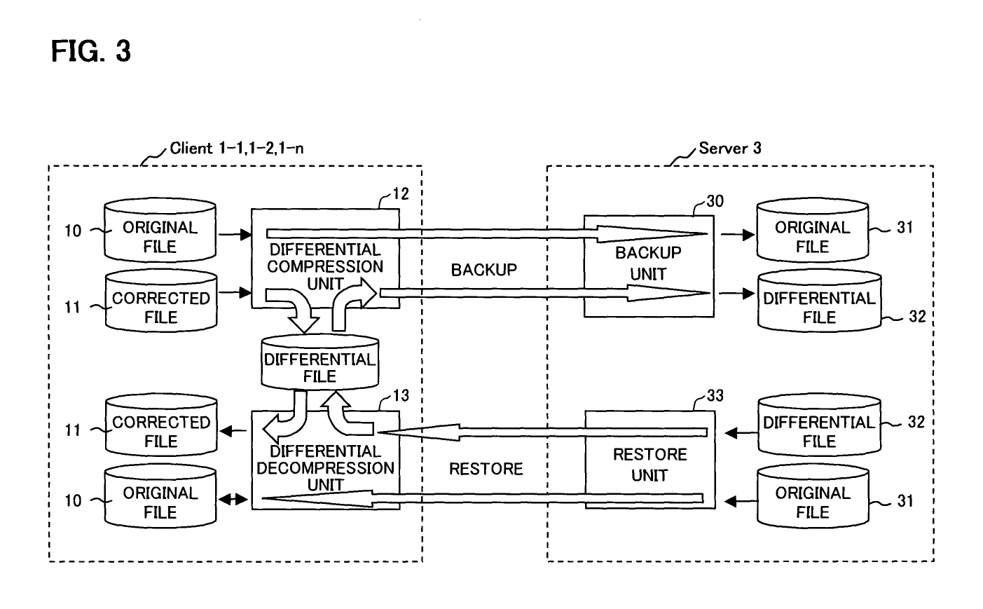

FIG. 3 is a diagram depicting a basic concept of the backup system between client and server according to the differential data transfer of the present invention. When the original file 10 and the corrected (updated or changed) file 11 thereof exist at client sides 1-1, 1-2 and 1-n, the differential compression processing. 12 between the original file 10 and the corrected file 11 is executed, and only the difference data thereof is sent to the server 3 side. The server 3 side stores and saves the transmitted original file 31 and the difference data 32 (this of course includes link association information thereof).

When the data is restored, the server 3 side reads the original file 31 and the difference data 32 (including link association information), and sends it back to the clients 1-1, 1-2 and 1-n. The clients 1-1, 1-2 and 1-nexecute the differential decompression processing from the original file and difference data using the link association information, and restores the corrected file 11. In this way the restoration operation is completed.

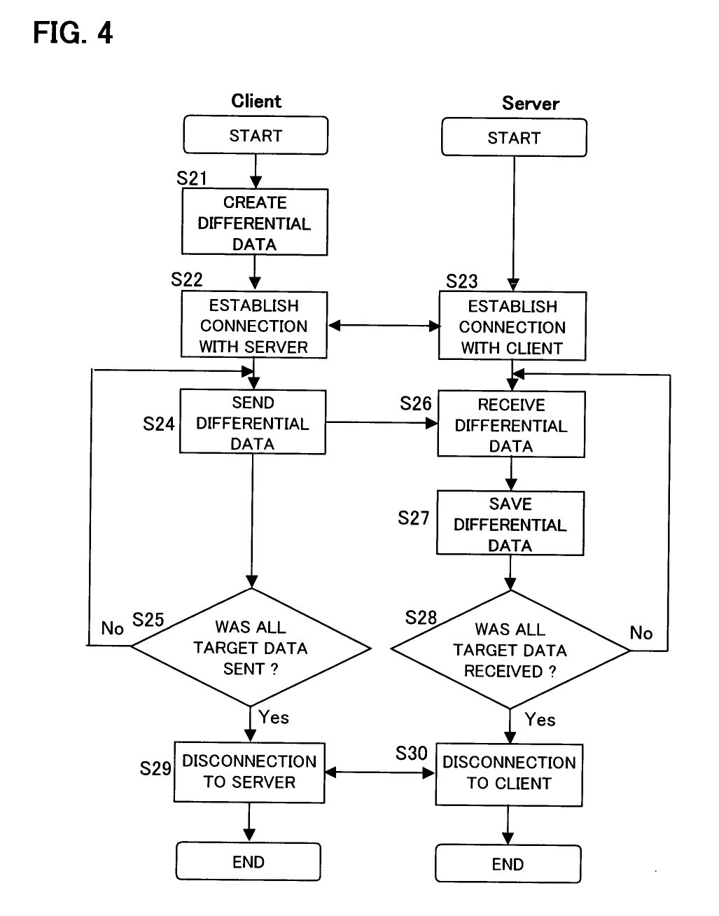

FIG. 4 is a diagram depicting a procedure of the backup transfer using the differential compression of the present invention.

S21: The client side creates a desired difference data before connected with the server. For example, just before backup, difference data is created for an updated file or a changed file, or non-periodic difference data is created when a file is updated or when a file is changed between backups.

S22: After difference data is created, the client side establishes a connection with the server.

S23: The server side establishes a connection with the client as well.

S24: After connection is established, the client side sends difference data to the server side.

S25: When the client side sent all the target data, processing advances to S29, otherwise, processing returns to S24.

S26: The server side receives the difference data.

S27: The server stores and saves the transmitted difference data as is.

S28: When the server side received all the target data, processing advances to step S30, otherwise, processing returns to step S26.

S29: The client side terminates connection with the server, and transfer completes.

S30: The server side terminates connection with the client, and transfer completes.

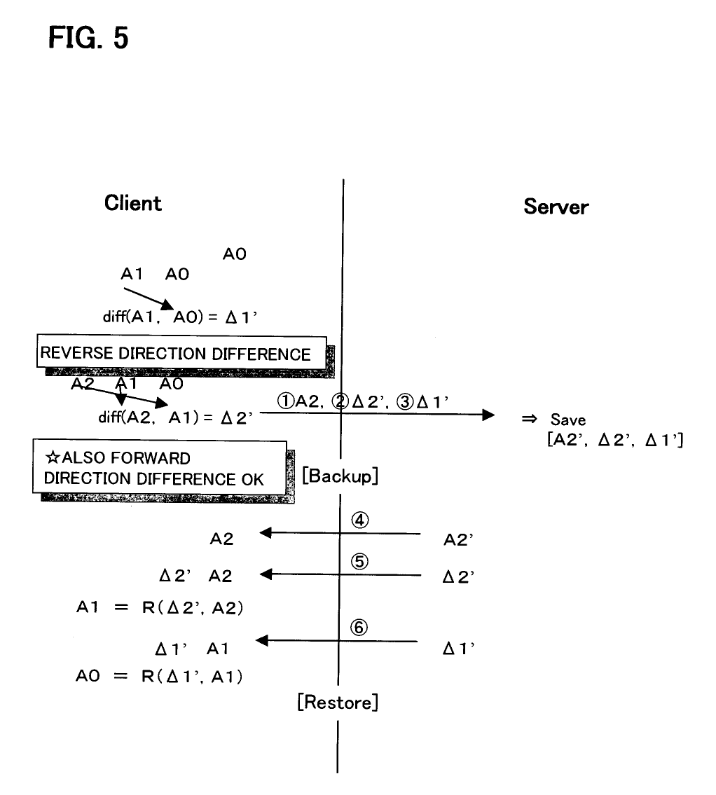

FIG. 5 is a diagram depicting a specific example of backup by differential compression in the system in FIG. 3 and FIG. 4.

It is assumed that the original file A0, the update file A1 thereof, and the update file A2 thereof are the targets of backup at the client side. At first, the client side determines all the differences Δ1′=diff(A1, A0), Δ2′=diff(A2, A1) in advance. In this example, linear difference in the backward direction is performed. And the processing is the same for linear difference in the forward direction as well.

Then the client side establishes connection with the server, sends the latest file A2 and difference data Δ240 and Δ1′ to the server, and the server side stores and saves this data as is.

To restore the data, the server side transfers the data to the client side in the same sequence of differences as when the data was sent (linear difference in the backward direction), that is the sequence of A2, Δ2′, Δ1′. And the client side restores the file A1 and A0 in the reverse sequence from the latest file A2.

In this way, the client side creates difference data by an appropriate difference creation method in advance according to the request of the user (the procedure in which the desired file will be restored at restoration time), then establishes connection and transfers the difference data to the server side, therefore overhead due to the difference transfer (backup) at the client side can be decreased.

Since difference data according to the restoration request has already been created at the client side, the server side can only save the data as is, and also returns the data to the client side as is at restoration, therefore load at the server side is also decreased considerably.

[Processing by Client]

Now processing for determining difference before the client side transfers data will be described. There are two cases to determine the time to determine difference, creating difference in batch just before transfer, and non-periodically creating difference each time a file is corrected during the period from the previous backup (time T1) to backup this time (time T2), targeting the forward difference and backward difference, and the following are the four possible combinations.

(1) Batch Difference Creation+Forward Difference Transfer:

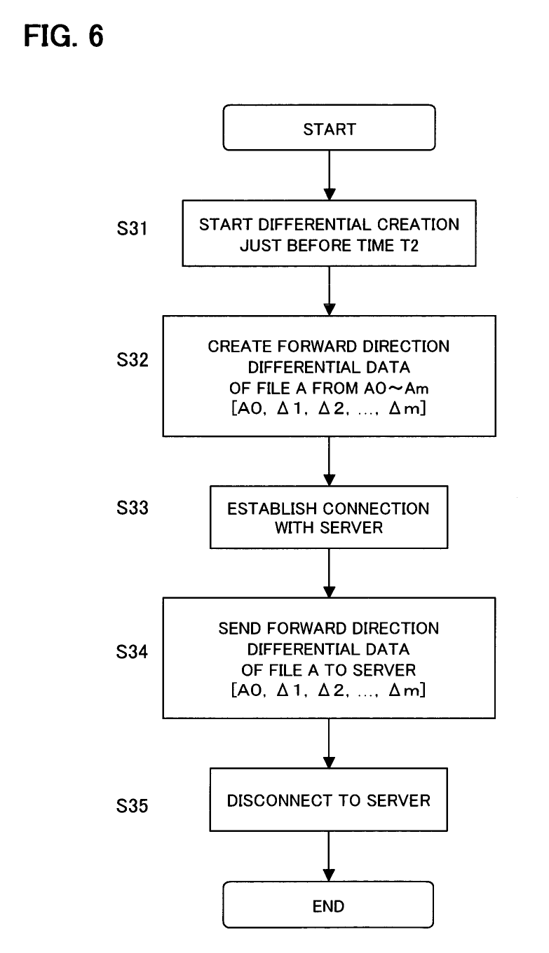

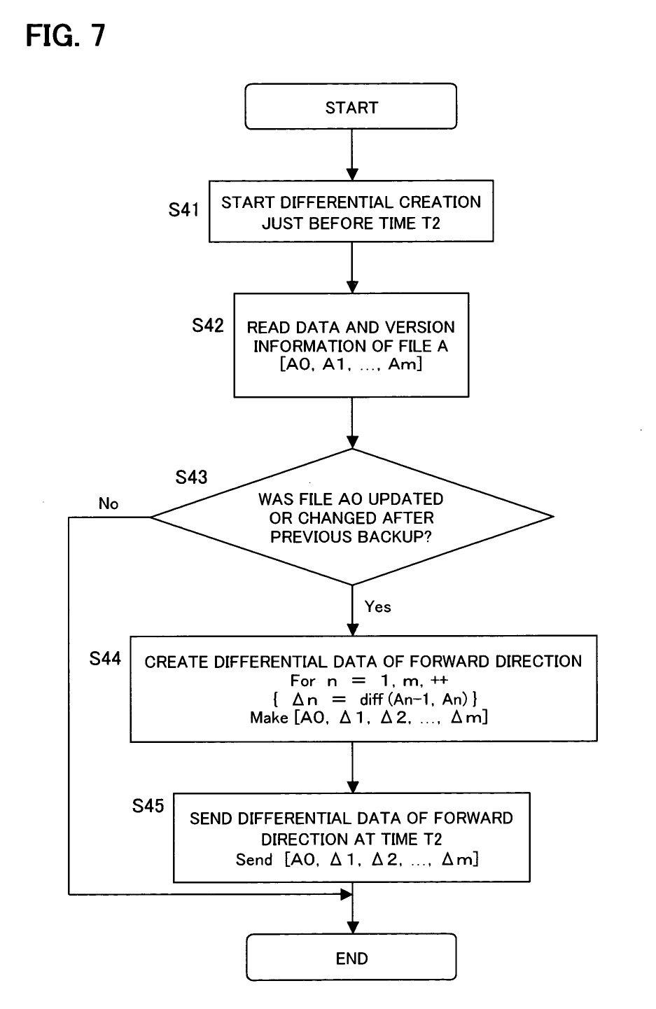

FIG. 6 is a flow chart depicting transfer processing when the client side creates difference in batch and transfers forward difference, and FIG. 7 is a flow chart depicting the difference data creation processing in FIG. 6.

S31: Difference creation is started just before time T2.

S32: The forward difference data [A0, Δ1, Δ2, . . . Δm] is created from the file groups A0−Am on the file A according to FIG. 7.

S33: Connection with the server is established.

S34: The already created forward difference data [A0, Δ1, Δ2, . . . Δm] on the file A is sent to the server side.

S35: Connection with the server is terminated.

Next, FIG. 7 is a flow chart depicting detailed processing of the difference data creation processing (S32) in FIG. 6.

S41: Difference creation is started just before backup time T2.

S42: File groups A0−Am on the file A and the version information [A0, A1, A2, . . . Am] thereof are read.

S43: If the file A0 has been updated or changed since the previous backup, processing advances to step S44, and otherwise, processing ends.

S44: The forward difference data is created from the information created in step S42 using the following program.

For n=1, m, ++

[Δn=diff(An−1, An)]

Make [A0, Δ1, Δ2, . . . , Δm]

S45: Already created forward difference data is sent to the server side at time T2.

Send [A0, Δ1, Δ2, . . . , Δm]

(2) Batch Difference Creation+Backward Difference Transfer:

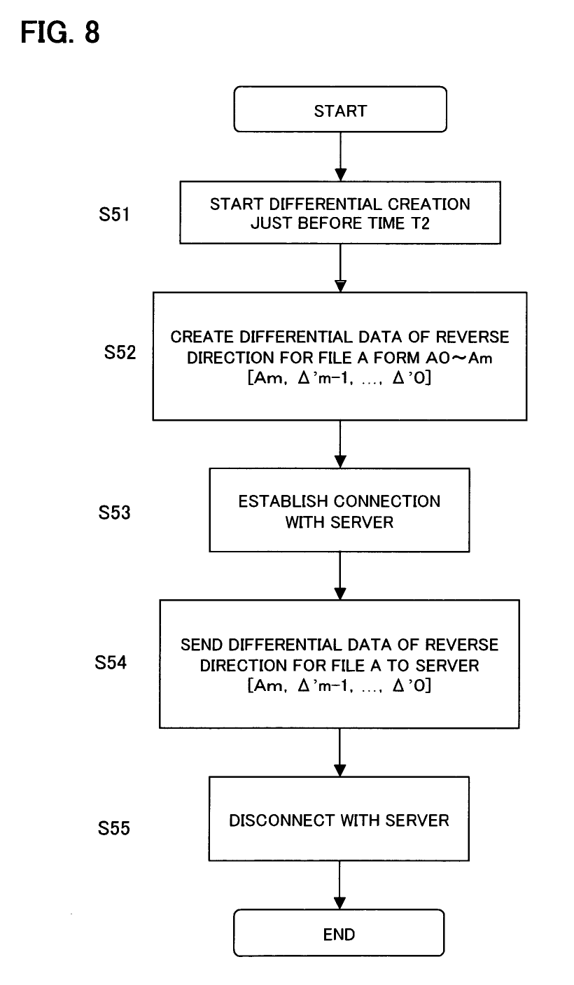

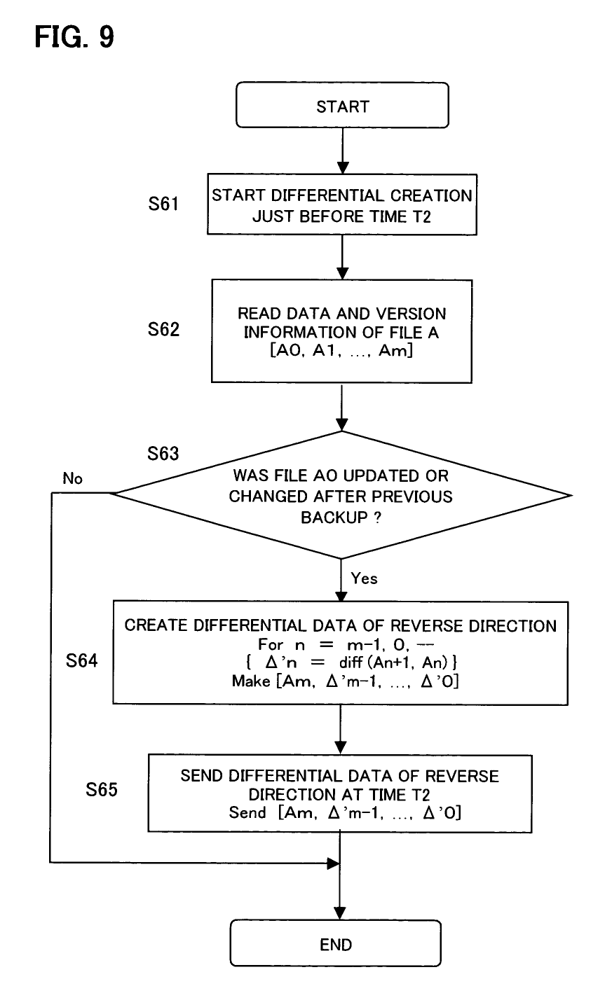

FIG. 8 and FIG. 9 describe processing when the client side creates difference in batch and transfers backward difference. FIG. 8 is a flow chart depicting the transfer processing when the client side creates difference in batch and transfers backward difference, and FIG. 9 is a flow chart depicting the difference data creation processing in FIG. 8.

S51: Difference creation is started just before time T2.

S52: The backward difference data [A0, Δ1, Δ2, . . . , Δm] is created from the file groups A0−Am on the file A according to FIG. 9.

S53: Connection with the server is established.

S54: Already created backward difference data [A0, Δ1, Δ2, . . . , Δm] on the file A is sent to the server side.

S55: Connection with the server is terminated.

next, FIG. 9 is a flow chart depicting detailed processing of the difference data creation processing (S52) in FIG. 8.

S61: Difference creation is started just before the backup time T2.

S62: File groups A0−Am on the file A and the version information [A0, A1, A2, . . . , Am] thereof are read.

S63: If the file A0 has been updated or has been changed since the previous backup, processing advances to step S64, otherwise, processing ends.

S64: The backward difference data is created from the information created in S62 using the following program.

For n=m−1, 0, −−

[Δ′n=diff(An+1, An)]

Make [Am, Δ′m−1, . . . , Δ′0]

S65: The backward difference data created at T2 is sent to the server side.

Send [Am, Δ′m−1, Δ′m−2, . . . , Δ′0]

(3) Non-Periodic Difference Creation+Forward Difference Transfer:

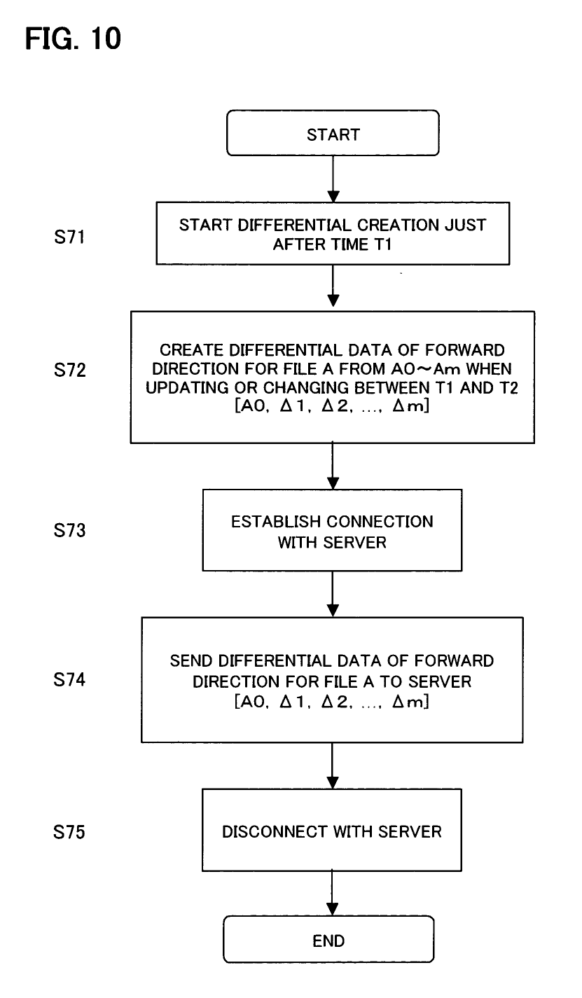

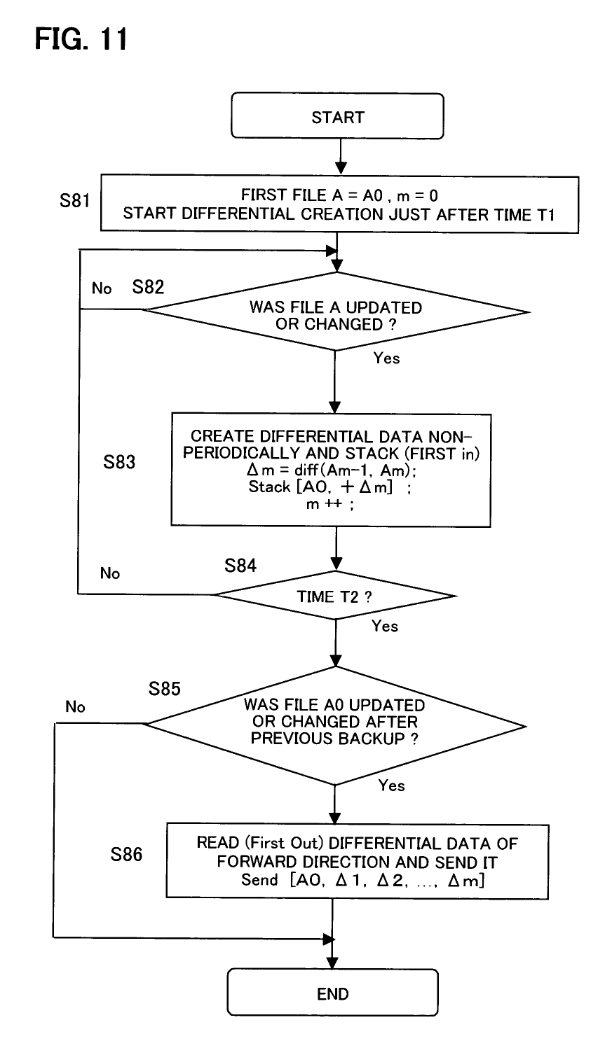

FIG. 10 is a flow chart depicting transfer processing when the client side creates non-periodic difference and transfers forward difference, and FIG. 11 is a flow chart depicting the difference data creation processing in FIG. 10.

S71: Difference creation is started immediately aftertime T1.

S72: The forward difference data [A0, Δ1, Δ2, . . . Δm] on the file A is created from the file groups A0−Am between times T1-T2 according to FIG. 11.

S73: Connection with the server is established.

S74: Already created forward difference data [A0, Δ1, Δ2, . . . , Δm] on the file A is sent to the server side.

S75: Connection with the server side is terminated.

Next, Detailed processing when the client side creates forward difference each time file A is updated or changed between time T1 and time T2 will be described with reference to FIG. 11.

S81: Difference creation is started immediately after time T1, regarding the first file A0, m=0.

S82: When the file A is updated or changed, processing advances to step S83.

S83: Each time the file A is updated or changed, forward difference data Δm is created and stacked as follows.

Δm=diff(Am−1, Am);

Stack [A0, +Δm]; m++;

S84: When the backup time T2 arrives, processing advances to step S85, otherwise processing returns to step S82.

S85: If the file A0 has been updated or changed since the previous backup, processing advances to step S86, otherwise, processing ends.

S86: Already created forward difference data is sent to the server side at time T2.

Send [A0, Δ1, Δ2, . . . , Δm]

(4) Non-Periodic Difference Creation+Backward Difference Transfer:

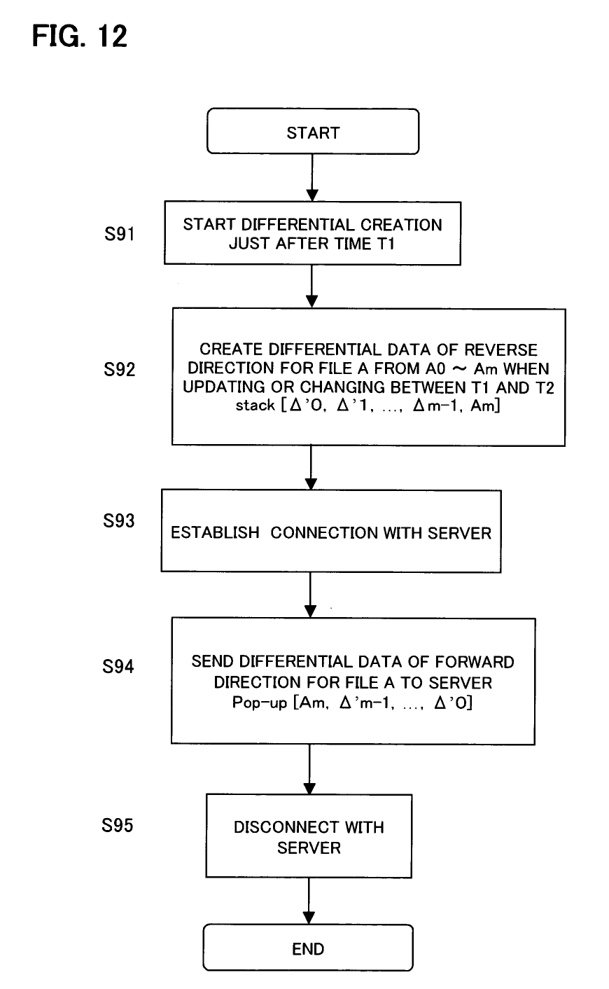

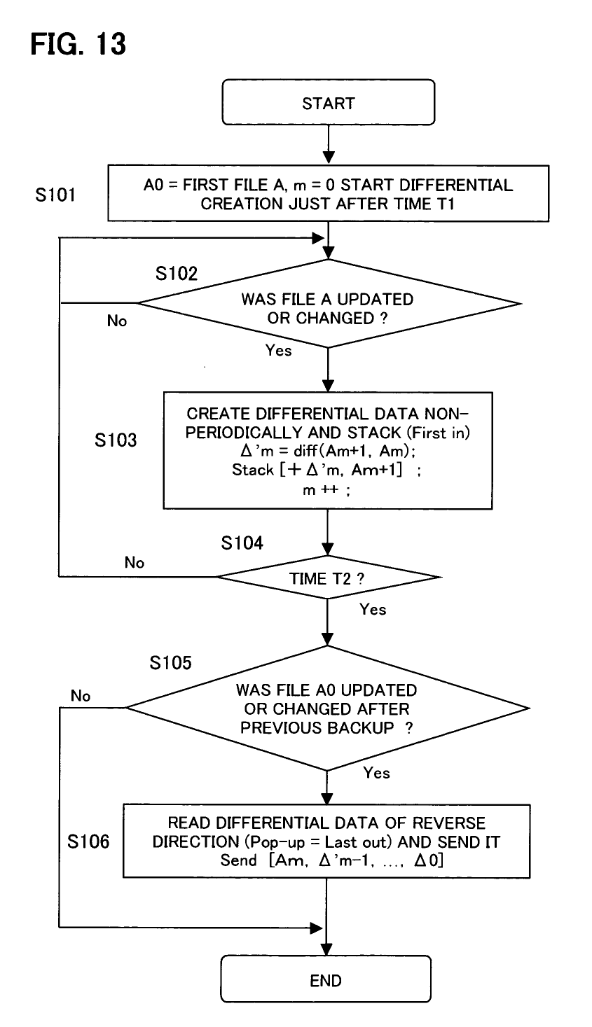

FIG. 12 is a flow chart depicting transfer processing when the client side creates non-periodic difference and transfers backward difference, and FIG. 13 is a flow chart depicting the difference data creation processing in FIG. 12.

S91: Difference creation is started immediately after time T1.

S92: The backward difference data [Δ′0, Δ1′, . . . Δm−1, Am] on the file A is created from the file groups A0−Am between times T1-T2 according to FIG. 13.

S93: Connection with the server is established.

S94: Already created backward difference data [Am, Δ′m−1, . . . , Δ′0] on the file A is sent to the server side.

S95: Connection with the server is terminated.

Next, Detailed processing when the client side creates backward difference each time the file A is updated or changed between times T1-T2 will be described with reference to FIG. 13.

S101: Difference creation is started immediately after time T1, regarding the first file as A0, m=0.

S102: When the file A is updated or changed, processing advances to step S103.

S103: Each time the file A is updated or changed, backward difference data Δ′m is created and stacked as follows.

Δ′m=diff(Am+1, Am);

Stack [+Δ′m, Am+1]; m++;

S104: When the backup time T2 arrives, processing advances to step S105, otherwise processing returns to step S102.

S105: If the file A0 has been updated or changed since the previous backup, processing advances to step S106, otherwise, processing ends.

S106: Already created backward difference data is read and is sent to the server side at time T2.

Send [Am, Δ′m−1, Δ′m−2, . . . , Δ′0]

[Processing by Server]

Now processing for backing up difference data by the server side according to the present invention will be described.

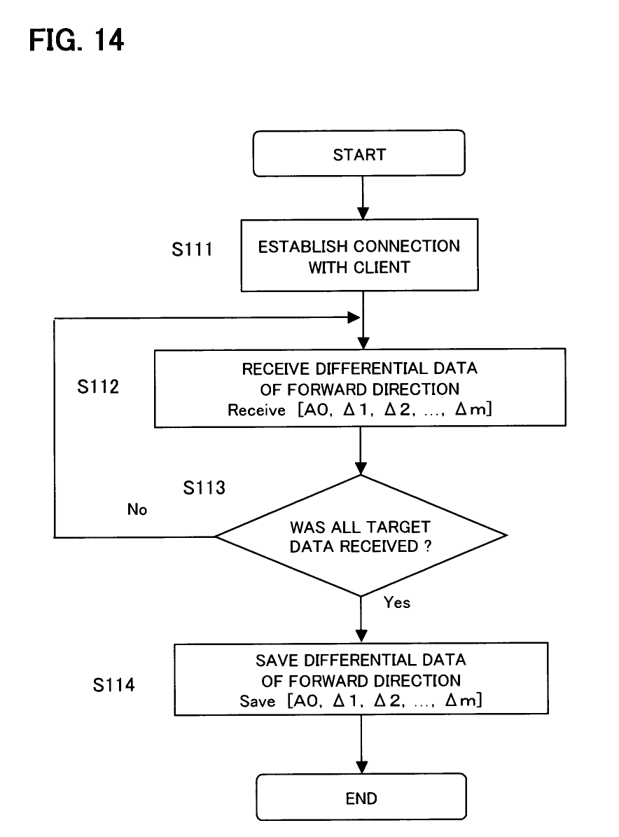

FIG. 14 is a flow chart depicting backup processing of forward difference by the server side according to the present invention.

S111: Connection with the client is established.

S112: Difference data in the forward direction is received along with link information.

Receive [A0, Δ1, Δ2, . . . , Δm]

S113: When all the target data is received, processing advances to step S114, otherwise processing returns to step S112.

S114: The difference data string in the forward direction is saved along with the link information, and processing ends.

Save [A0, Δ1, Δ2, . . . , Δm]

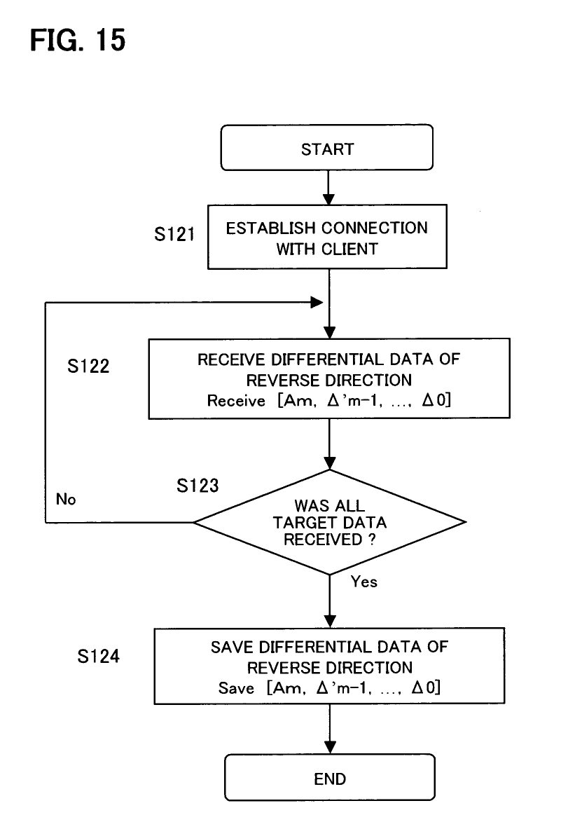

Next, FIG. 15 is a flow chart depicting the backup processing of backward difference by the server side according to the present invention.

S121: Connection with the client is established.

S122: Difference data in the backward direction is received along with the link information.

Receive [Am, Δ′m−1, . . . , Δ0]

S123: When all the target data is received, processing advances to step S124, otherwise processing returns to step S122.

S124: The difference data string in the backward direction is saved along with the link information, and processing ends.

Save [Am, Δ′m−1, Δ′m−2, . . . , Δ′0]

[Differential Data Compression Method]

Now a new method to determine difference (differential compression method) which satisfies the request of restoring the data most quickly (or restoring a certain range of data) will be described.

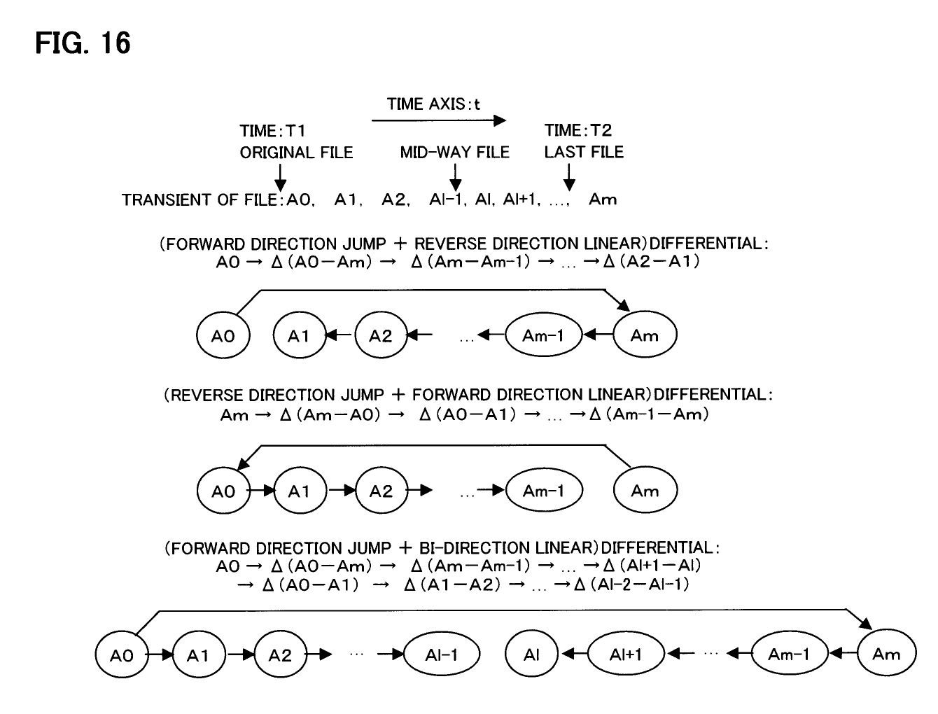

FIG. 16 is a diagram depicting an embodiment of the differential compression method according to the present invention. In FIG. 16, a mid-way file of the files A0−Am is assumed to be A1.

(1) (Forward Jump+Backward Linear) Difference:

In (1) of FIG. 16, the jump difference of Δ(A0−Am) is determined first, and the backward difference is determined as follows.

A0→Δ(A0−Am)→Δ(Am−Am−1)→ . . . →Δ(A2−A1)

By this, the file can be recovered as follows in the backward direction from the latest file Am.

A0→Am→Am−1 . . . →A1

(2) (Backward Jump+Forward Linear) Difference

In (2) of FIG. 16, the jump difference of Δ(Am−A0) is determined first, and the forward difference is determined as follows.

Am→Δ(Am−A0)→Δ(A0−A1)→ . . . →Δ(Am−1−Am)

By this, the first file A0 at the previous backup is restored from the last file Am, and the data can be restored in the sequence from an older file according to the time axis as follows.

Am→A0→A1→ . . . →Am−1

(3) (Forward Jump+Bi-Directional Linear) Difference

In (3) of FIG. 16, the jump difference in the forward direction and the bi-directional difference are determined as follows, so that the desired mid-way file can be restored most quickly.

$$A0 \to Δ ( A0 - Am ) \to Δ ( Am - Am - 1 ) \to … \to Δ ( A1 + 1 - A1 ) \to Δ ( A0 - A1 ) \to Δ ( A1 - A2 ) \to … \to Δ ( A1 - 2 - A1 - 1 )$$

By this, the desired mid-way file A1−1 or A1 can be restored most quickly as follows.

A0→Am→Am−1→ . . . →A1+1→A1

A0→A1→A2→ . . . →A1−2→A1−1

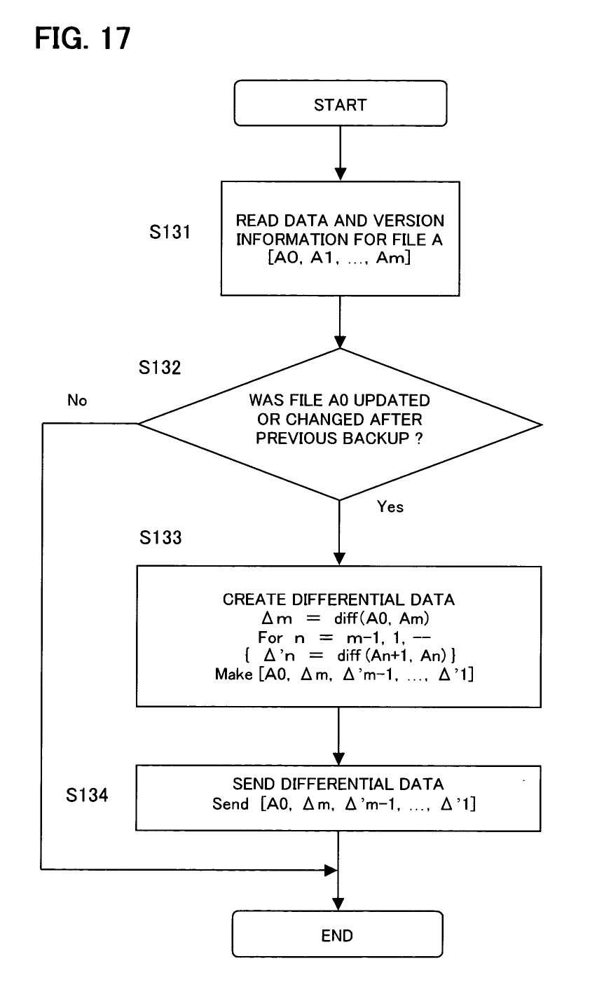

Now flow charts on the three types of specific difference creation and difference development will be described with reference to FIG. 17 to FIG. 22.

(1) (Forward Jump+Backward Linear) Difference

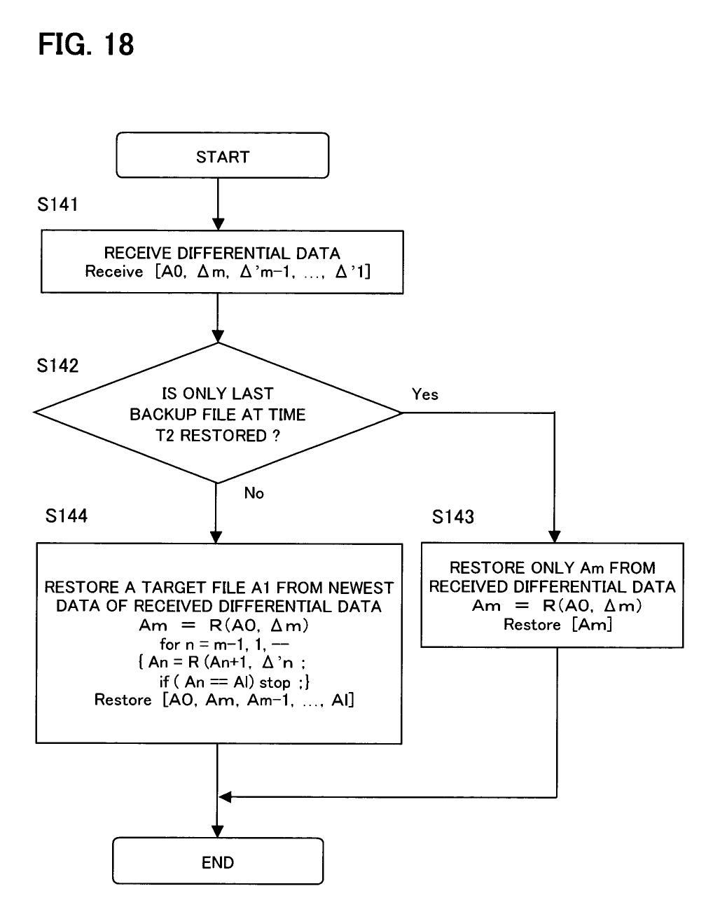

FIG. 17 and Fig. 18 are flow charts depicting the processing of forward jump+backward linear difference, and FIG. 17 shows the difference creation flow chart thereof.

S131: File groups A0−Am on the file A and the version information [A0, A1, A2, . . . , Am] thereof are read.

S132: If the file A0 has been updated or changed since the previous backup, processing advances to step S133, otherwise, processing ends.

S133: The forward jump+backward linear difference data is created as follows from the information of S131.

Δm=diff(A0, Am)

For n=m−1, 1, . . .

[Δ′n=diff(An+1, An)]

Make [A0, Δm, Δ′m−1, . . . , Δ′1]

S134: The already created forward jump+backward linear difference data string is sent to the server side at time T2, and processing ends.

Send [A0, Δm, Δ′m−1, . . . , Δ′1]

Next, FIG. 18 is a flow chart depicting forward jump+backward linear difference development processing.

S141: Forward jump+backward linear difference data is received.

Receive [A0, Δm, Δ′m−1, . . . , Δ′1]

S142: To restore only the file backed up last at time T2, processing advances to step S143, otherwise processing advances to step S144.

S143: Only the desired file Am is restored from the received difference data, and processing ends.

Am=R(A0, Am)

Restore [Am]

S144: Data from the latest data to the desired file A1 (or only this data) is recovered from the received difference data, and processing ends.

Am=R(A0, Δm)

for n=m−1, 1, −−

[An=R(An+1, Δ′n; if (An=A1) stop;]

Restore [A0, Am, Am−1, . . . , A1]

(2) (Backward Jump+Forward Linear) Difference

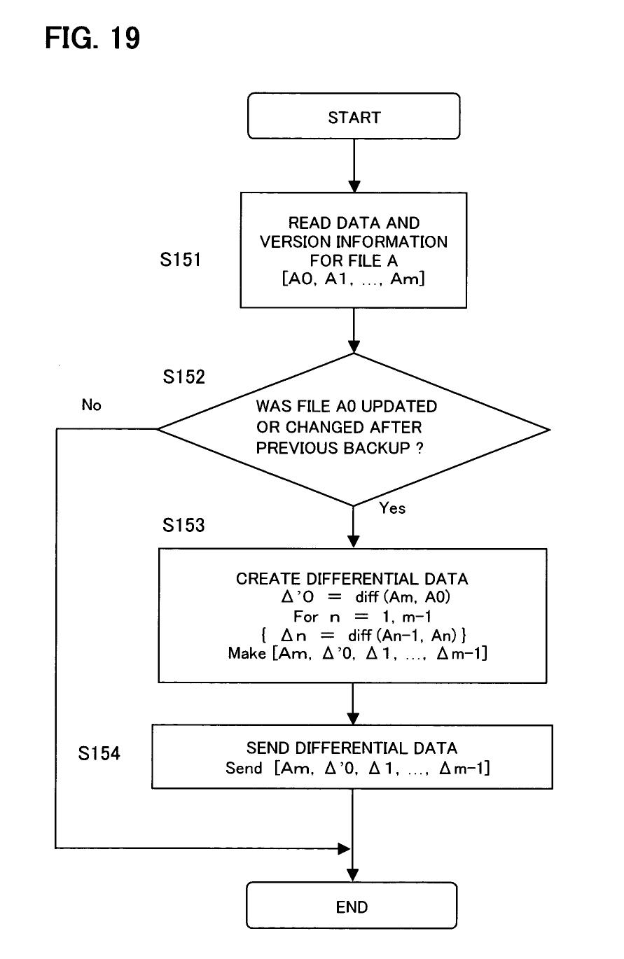

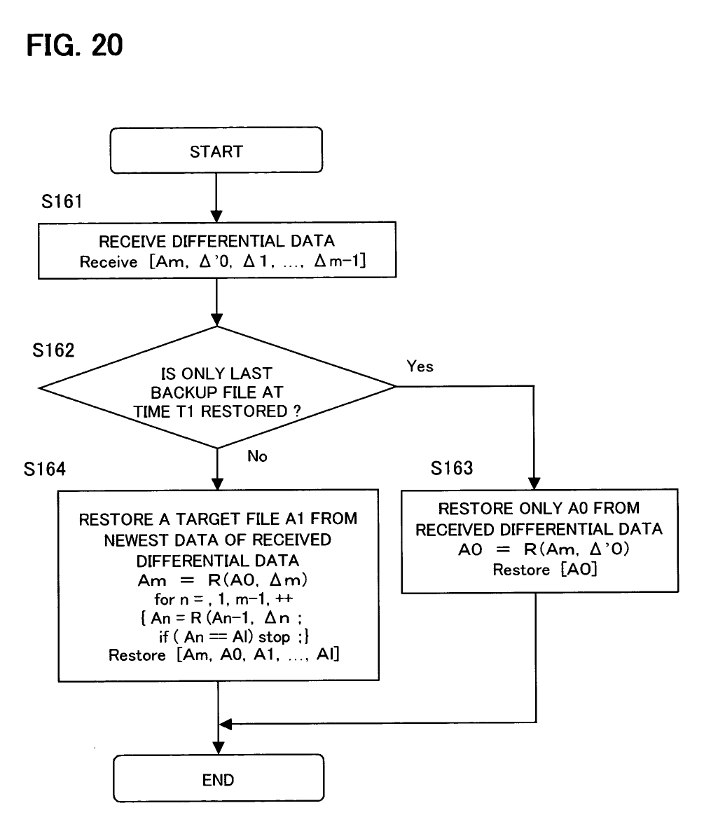

FIG. 19 and FIG. 20 are flow charts depicting the processing of backward jump+forward linear difference, and FIG. 19 shows the backward jump+forward linear difference creation processing flow chart thereof.

S151: File groups A0−Am on file A and the version information [A0, A1, A2, . . . , Am] thereof are read.

S152: If the file A0 has been updated or changed since the previous backup, processing advances to step S153, and if not, processing ends.

S153: The backward jump+forward linear difference data is created as follows from the information of step S151.

Δ′0=diff(Am, A0)

for n=1, m−1, ++

[Δn=diff(An−1, An)]

Make [Am, Δ′0, Δ1, . . . Δm−1]

S154: The already created backward jump+forward linear difference data string is sent to the server side at time T2.

Send=[Am, Δ′0, Δ1, . . . Δm−1]

Next, FIG. 20 is a flow chart depicting backward jump+forward linear difference development processing.

S161: Forward jump+backward linear difference data is received.

Receive [Am, Δ′0, Δ1, . . . , Δm−1]

S162: To restore only the file backed up first at time T2, processing advances to step S163, otherwise processing advances to step S164.

S163: Only the desired file A0 is recovered from the received difference data, and processing ends.

A0=R(Am, Δ′0)

Restore [A0]

S164: Data from an older data to the desired file A1 (or the desired file A1 only) is restored from the received difference data, and processing ends.

Am=R(A0, Am)

For n=1, m−1, ++

[An=R(An′1, Δn; if (An==A1) stop;

Restore [Am, A0, A1, . . . , A1]

(3) (Forward Jump+Bi-Directional Linear) Difference

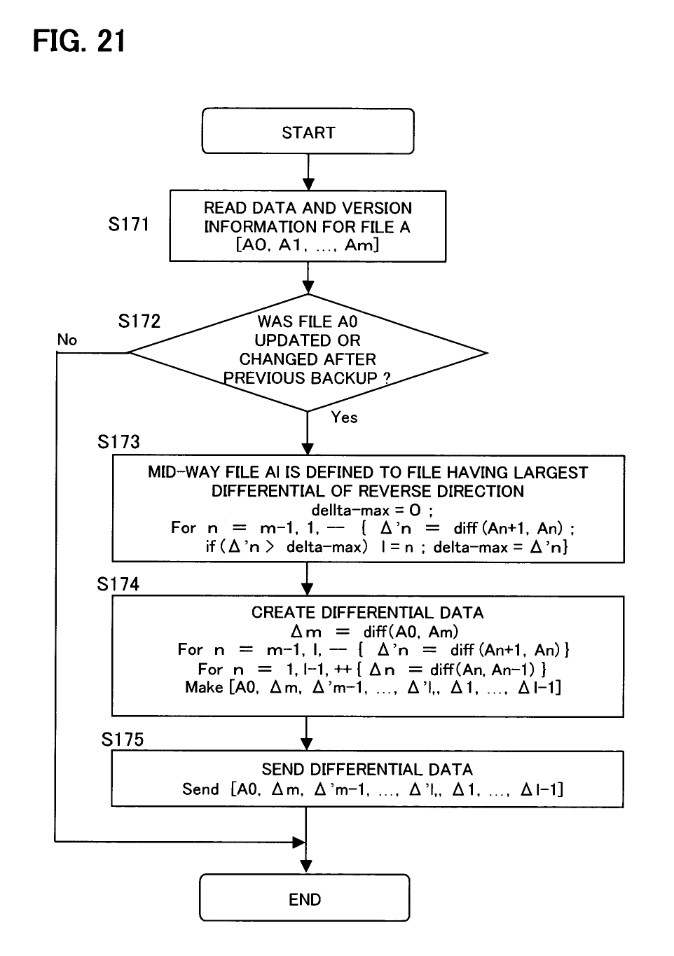

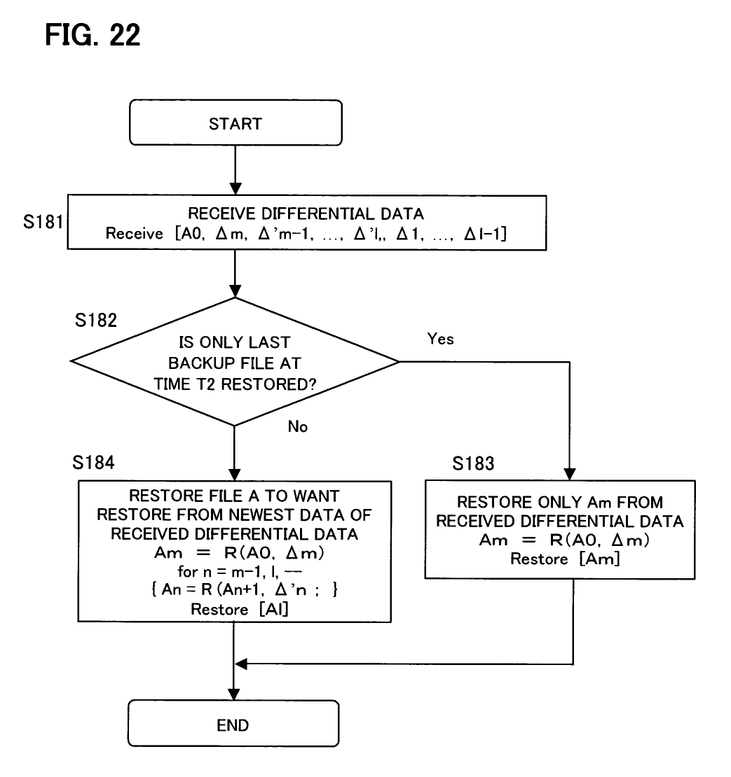

FIG. 21 and FIG. 22 are flow charts depicting the processing of forward jump+bi-directional linear difference, and FIG. 21 shows the forward jump+bi-directional linear difference creation processing flow.

S171: File groups A0−Am on file A and the version information [A0, A1, A2, . . . , Am] thereof are read.

S172: If the file A0 has been updated or changed since the previous backup, processing advances to step S173, otherwise, processing ends.

S173: A file in the mid-way file A1 is determined as follows from the information in Step S171 assuming the file with the largest backward difference as the mid-way file A1. This is to decrease the total difference.

delta-max=0;

For n=m−1, 1, −− [Δ′n=diff(An+1, An);

if (Δ′n>delta-max) 1=n; delta-max=Δ′n)

S174: Forward jump+bi-directional linear difference data from the mid-way file A1 is created as follows.

Δm=diff(A0, Am);

For n=m−1, 1, −− [Δ′n=diff(An+1, An)];

For n=1, 1−1, ++ [Δn=diff(An, An−1)];

Make [A0, Δm, Δ′m−1, . . . , Δ′1, Δ1, . . . , Δ1−1]

S175: The already created forward jump+backward linear difference data string is sent to the server side at time T2, and processing ends.

Send [A0, Δm, Δ′m−1, . . . , Δ′1, Δ1, . . . , Δ1−1]

Next, FIG. 22 is a flow chart depicting this forward jump+bi-directional linear difference development processing.

S181: Forward jump+backward linear difference data is received.

Receive [A0, Δm, Δ′m−1, . . . , Δ′1, Δ1, . . . , Δ1−1]

S182: To restore only the file backed up last at time T2, processing advances to step S183, otherwise processing advances to step S184.

S183: Only the desired file Am is restored from the received difference data string as follows, and processing ends.

Am=R(A0, Am)

Restore [Am]

S184: Only the desired file is restored from the received difference data string as follows, and processing ends.

Am=R(A0, Am)

for n=m−1, 1, −−

[An=R(An+1, Δ′n]

Restore [A1]

[Other Embodiments]

In the above embodiments, the difference compression and development methods of the client-server model was described by four types, but one of these types may be mounted, or a plurality of these types may be mounted so that the user can choose. Also the differential compression method described with reference to FIG. 16 and the drawings thereafter can be applied not only to the backup models in FIG. 1 and FIG. 2, but also to other backup models.

The present invention was described by the embodiments, but various modifications are possible within the scope of the essential character of the present invention, and these shall not be excluded from the technical scope of the present invention.

In the present invention, the difference data is created (according to the request of the user for restoring the data) before transfer, and only already created difference data is sent during transfer, so overhead at the client side and the server side can be decreased.

When the new methods of determining difference shown in the embodiments are used, or these methods are combined, detailed data can be restored according to the request of the user.

What is claimed is:

1. A backup method by differential compression for backing up data of a client by a server, comprising the steps of:
creating associated differential compression data groups before backup with a client;
connecting with said server and transferring said differential compression data groups and association information created by said client to said server at backup;
saving said differential compression data groups to a storage medium of said server according to the transferred association information and disconnecting said connection;
reading said saved differential compression data groups according to the association information and transferring the data groups from said server to said client when the data is restored; and
decompressing and developing said differential compression data groups according to the transferred association information and rebuilding data with said client.

2. The backup method by differential compression according to claim 1,
wherein said creating step comprises a step of performing linear difference in the forward direction in time from old data to new data when said client associates the differential compression data.

3. The backup method by differential compression according to claim 1,
wherein said creating step comprises a step of performing linear difference in the backward direction in time from new data to old data when said client associates the differential compression data.

4. The backup method by differential compression according to claim 1,
wherein said creating step comprises a step of creating the differential compression data in batch immediately before backup according to said association.

5. The backup method by differential compression according to claim 1,
wherein said creating step comprises a step of creating the differential compression data non-periodically between backup and backup along with said association.

6. The backup method by differential compression according to claim 4,
wherein said creating step comprises:
a step of creating the differential compression data in the backward direction non-periodically between backup and backup along with said association; and
rearranging the backward difference data in the opposite direction to transfers the data.

7. The backup method by difference compression according to claim 1,
wherein said saving step comprises a step of saving said difference data groups according to forward linear association when said differential compression data groups are saved to a storage medium.

8. The backup method by differential compression according to claim 1,
wherein said saving step comprises a step of saving said difference data groups according to the backward linear association when said differential compression data groups are saved to a storage medium.

9. A backup system using differential compression for a server to backup data of a client, comprising:
a client which creates associated differential compression data groups before backup, then connects with said server, and transfers said created differential compression data groups and association information to said server at backup; and
a server which saves said differential compression data groups to a storage medium according to said transferred association information and disconnects said connection,
wherein, when data is restored, said server reads said saved differential compression data groups according to the association information, transfers said data and information to said client, and
said client decompresses and develops said differential compression groups according to the transferred association information, and rebuilds the data.

10. The backup system using differential compression according to claim 9,
wherein the linear difference in the forward direction in time from old data to new data is determined when said client associates the differential compression data.

11. The backup system using differential compression according to claim 9,
wherein the linear difference in the backward direction in time from new data to old data is determined when said client associates the differential compression data.

12. The backup system using differential compression according to claim 9,
wherein, in order to create the differential compression data, said client creates the differential compression data in batch immediately before backup according to said association.

13. The backup system using differential compression according to claim 9,
wherein, to create the differential compression data, said client creates the differential compression data non-periodically between backup and with said association.

14. The backup system using differential compression according to claim 11,
wherein said client creates said differential compression data in the backward direction between backup and backup along with said association for creation of differential compression data, rearranges the backward difference data in the opposite direction, and transfers the data.

15. The backup system using differential compression according to claim 9,
wherein said server saves said difference data groups according to forward linear association when said differential compression data groups are saved to a storage medium.

16. The backup system by difference compression according to claim 9, wherein said server saves said difference data groups according to backward linear association when said differential compression data groups are saved to a storage medium.

17. A difference compression method for associating data groups which are changed or updated with the difference between new data and old data, comprising:
a step of determining the jump difference in the forward direction from the first tile to the last file; and
a step of determining linear difference in the backward direction from said last file to the file next to said first file.

18. A difference compression method for associating data groups which are changed or updated by the difference between new data and old data, comprising:
a step of determining the jump difference in the backward direction from the last file to the first file; and
a step of determining the linear difference in the forward direction from said first file to the file just before said last file.

19. A difference compression method for associating data groups which are changed or updated by the difference between new data and old data, comprising:
a step of determining the jump difference in the forward direction from the first file to the last file, a step of determining the linear difference in the backward direction from said last file to a mid-way file; and
a step of determining the linear difference in the forward direction from said first file to the file just before said mid-way file.

20. The difference compression method according to claim 19, further comprising a step of defining said midway file by regarding a location where the line difference size is largest as the break point of association.
